(19) United States
(12) Patent Application Publication
(10) Pub. No.: US 2005/0091108 A1
(43) Pub. Date: Apr. 28, 2005

(54) Method and system for online game and interactive marketing

(76) Inventor: Scott Frost, Las Vegas, NV (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 10/932,694

(22) Filed: Sep. 1, 2004

Related U.S. Application Data
(60) Provisional application No. 60/499,792, filed on Sep. 2, 2003.

(51) Int. Cl. G06F 17/60; A63F 9/24; A63F 13/00

(52) U.S. Cl. 705/14; 463/42

(57) ABSTRACT

A method combines the use of an Internet address containing a word or phrase that conveys a known destination to a self-selected online user with an opportunity to play a game and to win valuable prizes. A first: time game player is asked to register and to input at least an e-mail address, and preferably to answer at least one destination-oriented question to have an opportunity to win at least one destination-oriented prize.

### CROSS-REFERENCE TO RELATED APPLICATIONS

This application claims priority to the U.S. provisional application entitled “Method and System For On-line Game and Interactive Marketing,” Application No. 60/499,792, filed Sep. 2, 2003, which is incorporated by reference herein.

### FIELD OF THE INVENTION

The present invention relates, generally, to online marketing and, more specifically, to a method and system for operating a gaming device by a self-selected class of game players based on their possible interests in traveling to a destination known to that class.

### BACKGROUND OF THE INVENTION

Typically, Internet users are bombarded by messages placed online by merchants to attract them to purchase an infinite variety of goods and services. The goal of the merchants is to tailor the messages with items of interest to attract the Internet users, who can respond by clicking an icon with a mouse, keyboard or other input device.

Traditionally companies have sold goods and services under trademarks and trade names that have now become household names. Since the advent of the World Wide Web and the Internet, these companies have had no trouble matching goods and services with users interested in purchasing such goods and services online. A user interested in goods and services sold by such companies can go on the Internet and instantly locate corresponding web pages. According to a survey in 1999, the companies with the largest number of U.S. trademark registrations included Avon Products, Inc., Johnson & Johnson, General Mills, Inc., Minnesota Mining and Manufacturing Company, Ralston Purina Company, American Greetings Corporation, American Home Products Corporation, E.I. Du Pont De Nemours and Company, and Clairol Incorporated. All a user has to do to be matched to a company's home page is to make an educated guess of a web address, e.g., “GeneralMills.com” or use the company's name in the search block of a search engine.

The same type of matching is much more difficult if there are a large number of small, medium and even large merchants vying to sell goods and services that are all located at the same geographic area, e.g., Las Vegas. It becomes very costly for each of these merchants to use the Internet to individually attract a sufficient number of online users to travel and become consumers at that area.

There are numerous online systems for attracting potential online consumers and building consumer information databases.

There is a need to have a less complex, but effective method of building a database of a self-selected class of consumer information. There is also a need for a better method of matching Internet users to merchants at certain geographic locations and to attract the users in traveling to and becoming consumers at those locations.

### BRIEF DESCRIPTION OF THE DRAWINGS

FIG. 1 illustrates a welcome screen of a home page in accordance with a preferred embodiment of the present invention.

FIG. 2 illustrates a second web page.

FIG. 3 illustrates a registration page for first time players.

FIG. 4 illustrates a web page for registered players who have forgotten their passwords.

FIG. 5A illustrates a web page for registered players who have entered corrects password before playing any of a plurality of games.

FIG. 5B illustrates a web page for registered players who have entered the correct password after playing all but one of the games.

FIG. 6A illustrates a scratch and win game page for registered players before the game is played.

FIG. 6B illustrates a scratch and win game page after the game has been played and a consolation prize is offered.

FIG. 6C illustrates a scratch and win game page after the consolation prize has been.

FIG. 7A illustrates a roulette wheel game page before a winning contestant of the scratch and win game has spun the roulette wheel for an opportunity to win the main.

FIG. 7B illustrates a roulette wheel game page after the winning contestant of the scratch and win game has spun the roulette wheel for an opportunity to win the main.

FIG. 8A illustrates a form for adding a new sponsor of a main prize in accordance with the present invention.

FIG. 8B illustrates a form for editing information on a sponsor of a main prize.

FIG. 9A illustrates a form for adding a new advertisement/consolation prize.

FIG. 9B illustrates a form for editing information on an advertisement/consolation.

### DETAILED DESCRIPTION OF PREFERRED EMBODIMENTS OF THE INVENTION

To facilitate its description, the invention is described below in terms of embodiments, and with reference to the figures.

In accordance with a preferred embodiment of the present invention, an online game and marketing method includes providing an Internet or e-mail address that includes a word, a phrase or other series of characters that conveys a destination to a self-selected class of online players. Typically such destinations include cities, countries, and other similar places where resorts and other places of attraction are located. Examples of Internet addresses for a couple of resort cities include “renoshotspots.com” and “vegashotspots.com” to convey to players the cities of Reno and Las Vegas, Nev. “DownInBermuda.com” might be the address for those players possibly having an interest in going to Bermuda. In accordance with a specific embodiment of the present invention, the selection of the addresses will avoid simply adding “.com” after the names of the destinations, which might conflict with the Internet or e-mail addresses already in use by the hosts of the municipality or other destinations. The exact choice of the address preferably depends on a domain search to make sure there is no conflict. It is desirable to select an address containing a series of letters or other characters that readily conveys the name of destination to anyone seeing the address.

A next step in the method is attracting the target online players who have possible interest in traveling to the destination. The Internet address is made available to numerous search engines by the host controlling the website address. The search engines make the Internet address readily accessible to a player requesting a search of the destination contained within the address. The same host can also purchase online banner or other advertising or create video screen popups to attract players to click onto the icons leading to host's website.

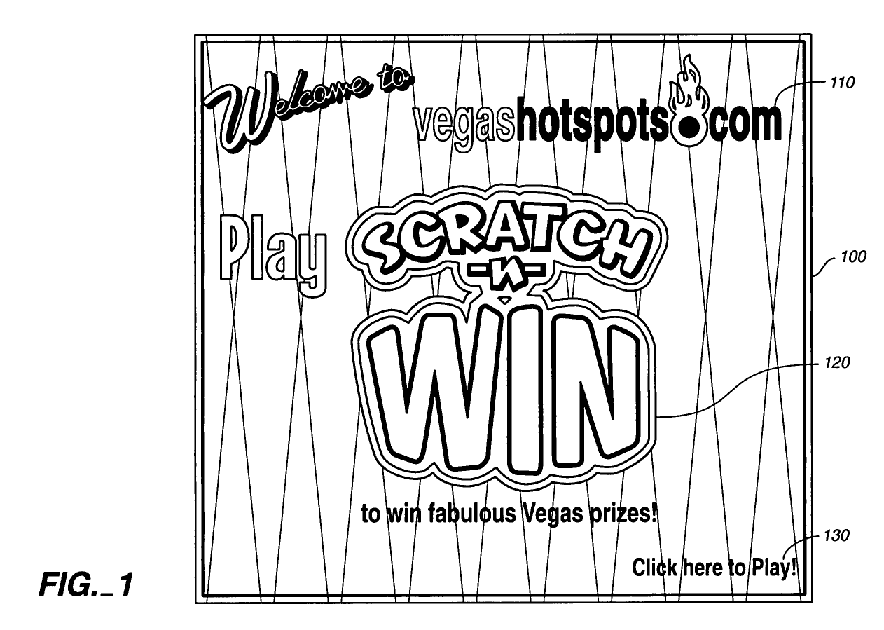

A subsequent step in the method is displaying a welcome screen of the home page offering the player an opportunity to play an online game. FIG. 1 shows a welcome screen 100 in accordance with an embodiment of the present invention. Welcome screen 100 has a plurality of icons, e.g., icons 110, 120, and 130 shown in FIG. 1, that link the player to other screens or web pages. Welcome screen 100 is designed to generate an interest in the player in traveling to the designation included in the Internet address. Welcome screen 100 also contains one or more icons that the player can click to proceed to next web page. At least one icon, e.g., icon 130 shown in FIG. 1, contains the text that calls for immediate action on the player's part to proceed, e.g., “Click here to play.”

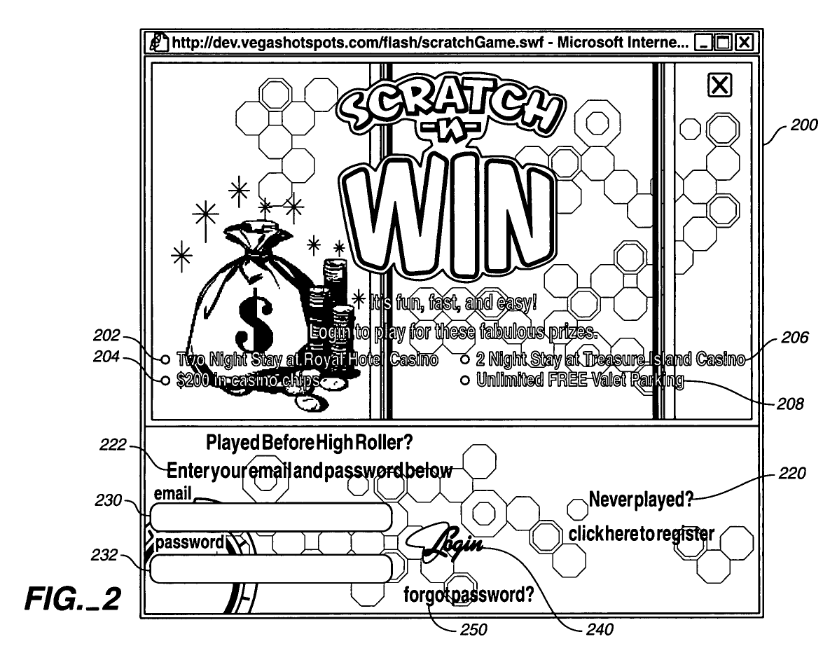

FIG. 2 shows a second screen or web page 200 for a “Scratch and Win” game in accordance with the present invention. On web page 200, the player is offered a chance to win prizes or other rewards that are destination-oriented, e.g., the prizes shown in icons 202, 204, 206, and 208 in FIG. 2. The content of web page 200 preferably includes a plurality of worthwhile prizes offered by various sponsors that desire to attract the player to travel to the destination. By way of example, these sponsors are merchants, owners of hotels, casinos, restaurants, and the like. They donate the prizes for the opportunity to sell various goods and services to players traveling to the destination. In many instances, the host controlling the website contracts with the sponsors to exchange valuable prizes for a database of players that have a possible interest in traveling to the destination. Examples of the destination-oriented prizes include a free two-night stay at a hotel or a certain number of chips for playing at a specific casino.

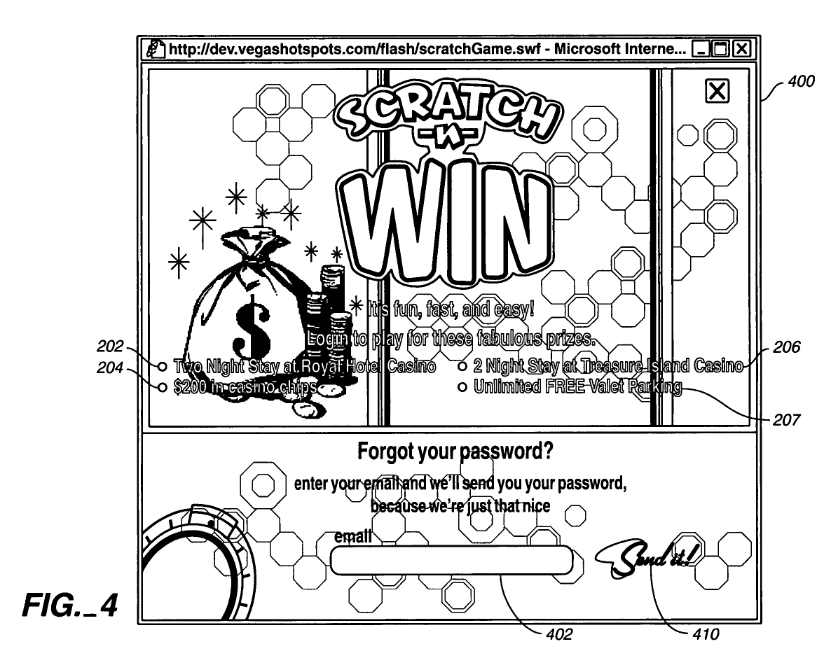

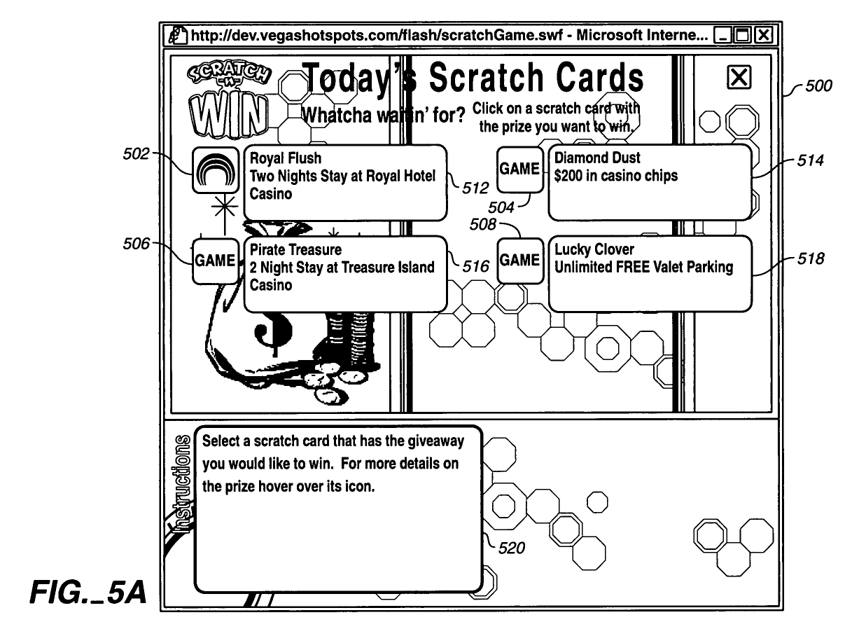

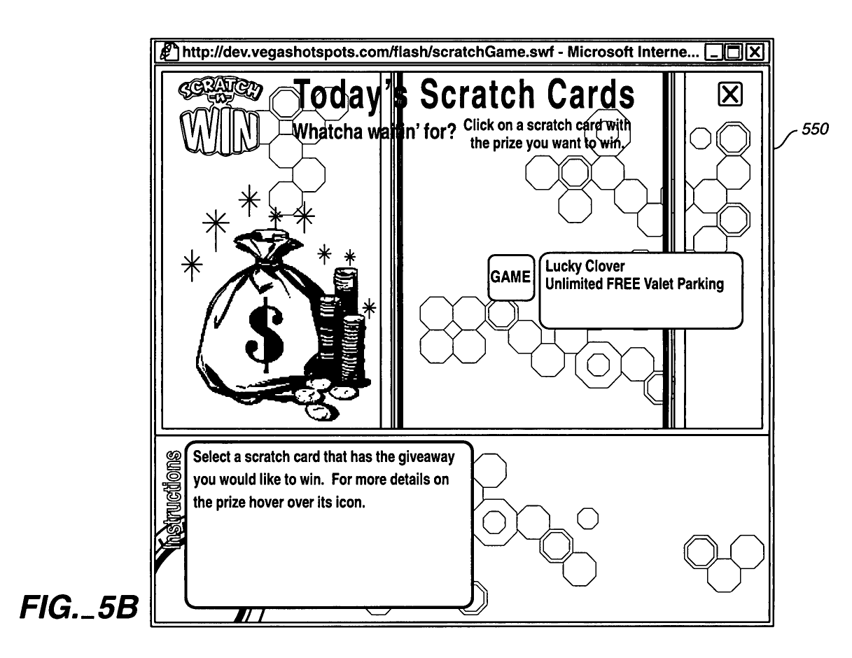

In accordance with an embodiment of the present invention, the method also offers the player on web page 200 a list of the prizes or other rewards that the players can win if they proceed to play the game. There are two choices a player has at this point. The player can click onto an icon 220 with message requesting first time players to register. Alternatively, an icon 222 requests registered players to simply input their e-mail address in a box 230 and preferably a password in a box 232 to login (icon 240) and move to the next level as shown on FIG. 5A. A registered player who forgets the password can click on an icon 250 to proceed to a screen shown in FIG. 4.

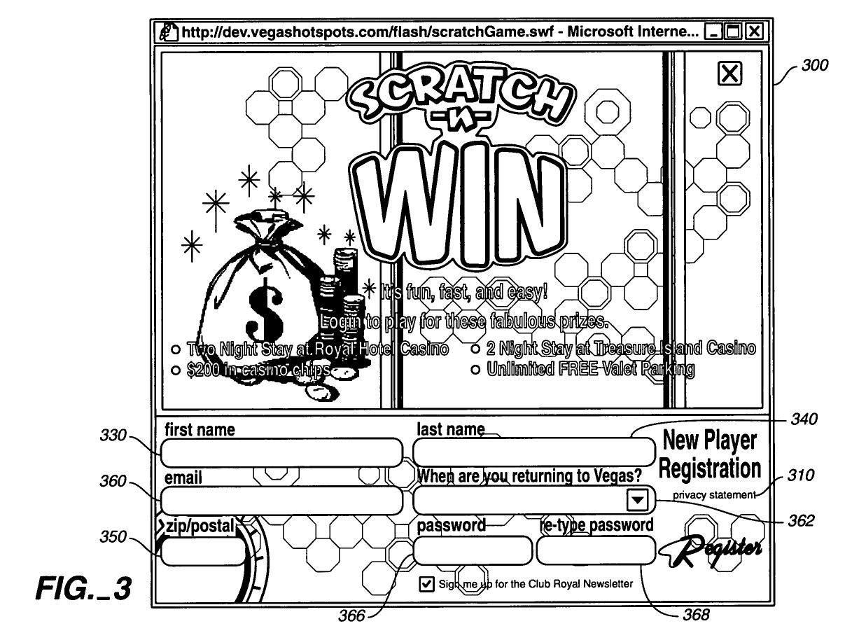

FIG. 3 illustrates a registration web page 300 presented to the players who click on registration icon 220 shown in FIG. 2. Preferably, all first time players must register before being allowed to play the game. To register, the player must provide at least one piece of player information, preferably the player's e-mail address (box 360). Another piece of player information that is preferably asked and shown in FIG. 3 is a box 362 to indicate the player's plans for the next trip to the destination, such as how long before the player plans on returning to the destination. The e-mail address combined with the travel plans of the player are valuable information to the sponsors of the website. Built into the web site content are that incorrect e-mail addresses inputted by the player will result in error messages. For example, inputting a partial e-mail message without a proper “@” extension will not permit the player to proceed. If the player attempts to input, for example, an invalid password, “NULL” will appear with a display of a message “Invalid Username/Password.” Web page 300 may also request other information from the registering player, e.g., first name (box 330), last name (box 340), zip code (box 350), password (box 366), password confirmation (box 368). In addition, web page 300 may include a link (icon 310) to a screen showing the legal statements and/or disclaimers, e.g., privacy policy, terms of use, etc., of the website host.

FIG. 2 shows icon 250 with the message “Forgot Your Password?” that a registered player can click. This step is only used if the player can not remember the password. It the player clicks on icon 250, a web screen 400 is displayed as shown in FIG. 4. On web page 400, the player can have the password sent to the player's e-mail address by entering the e-mail address in a box 402 and clicking an icon 410 to send the e-mail address to the website. Optionally, the website host's database contains a reminder word or phrase chosen by the player that allows the player to proceed with the game. FIG. 4 displays the list of prizes and other text to continue to encourage the player to continue to play the game.

FIG. 5A shows a web page 500 either displayed in response to either the registered player having successfully logged in or the first time player having registered. Web page 500 instructs (icon 520) the player to select one prize from a plurality of prizes (icons 512, 514, 516, and 518) donated by the various sponsors. In accordance with a specific embodiment, icons 512, 514, 516, and 518 include links to web pages that provide detailed description of the prizes. The player is permitted to play some or all of the plurality of the games within a given time period. For example, in a preferred embodiment, the player may try for the plurality of prizes every 24 hours until all such tries for the prizes have been placed on the next level as discussed below. In the web page 500 shown in FIGURE SA, four “scratch card” icons 502, 504, 506, and 508 are shown for the four prizes and instructions (icon 520) are given to the player to click on the scratch card the player selects to try to win. Web page 500 may also include a box (not shown in FIG. 5A) that is filled in with more information about the prize if the player hovers over the selected icon with the cursor of a mouse or other input device. FIG. 5B shows a screen display 550, which evolves from web page 500 shown in FIG. 5A when the player has only one more prize in the attempt to get to the next level in the online gave in accordance with an embodiment of the method of the present invention. By way of example in screen display 550, the remaining prize is unlimited free valet parking at a sponsor's hotel.

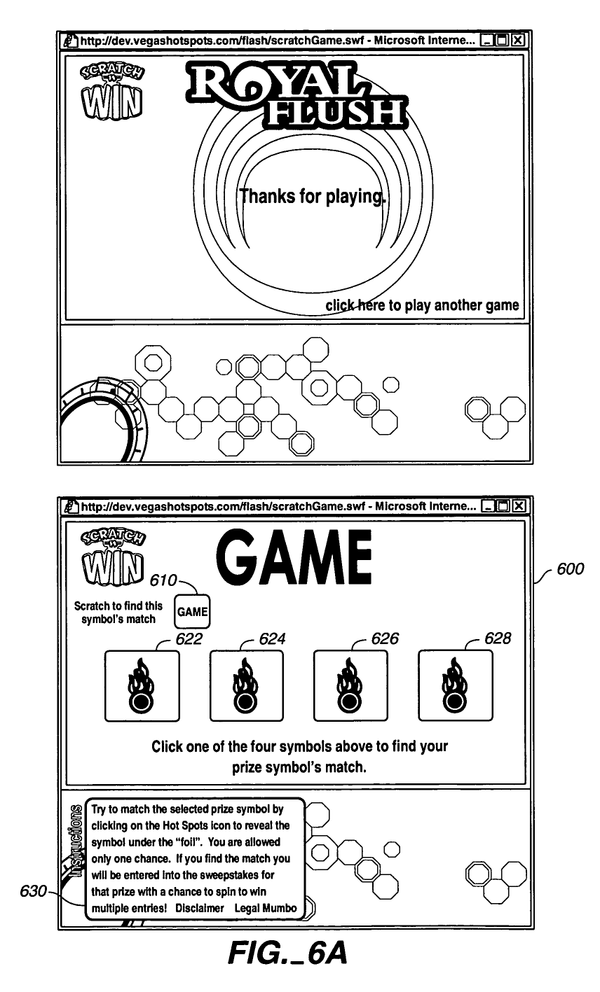

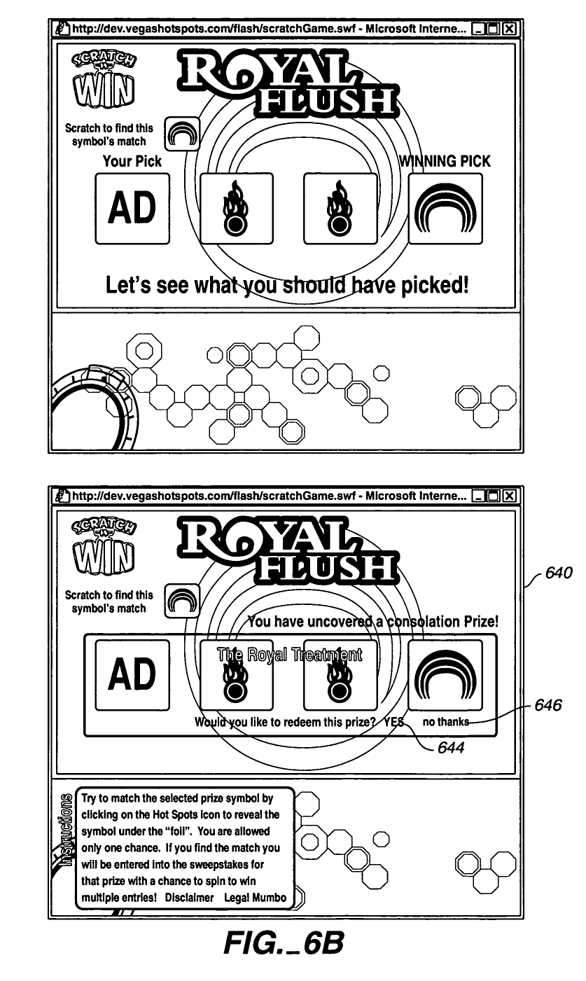

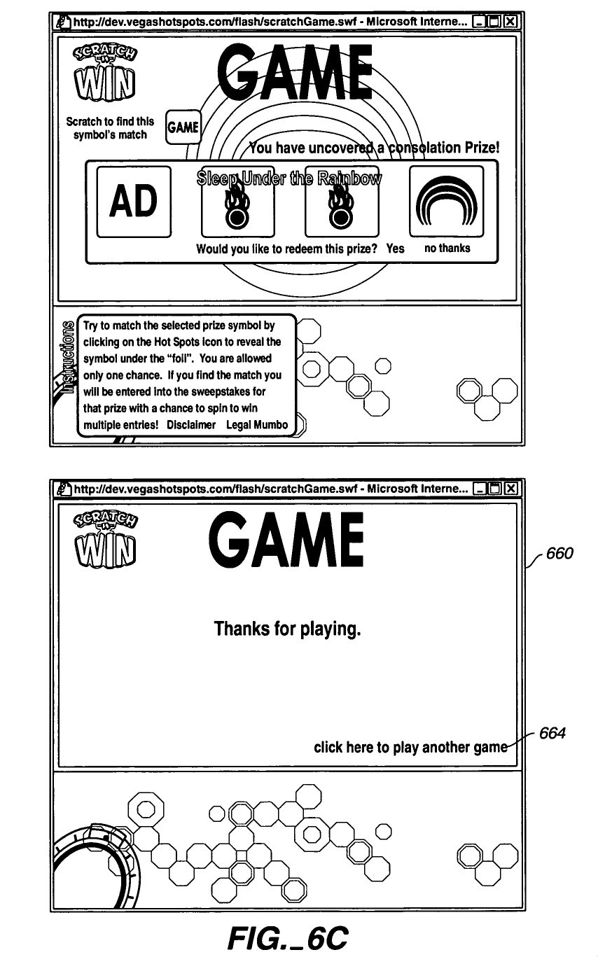

FIG. 6A illustrates a display screen 600 of in the next step, which instructs (box 630) the player to play the game and possibly receive the selected prize. In a preferred embodiment, even if the player fails to win the selected prize, the opportunity is given to receive a consolation prize. In this “Scratch and Win” game, the registered player is permitted to electronically “scratch” by clicking one of the symbols (icons 622, 624, 626, and 628). In response to the player clicking one of the symbols, an electronically controlled erasure or “scratch” uncovers either another symbol that matches a symbol 610 shown on FIG. 6A. If the player matches symbol 610, the screen flashes that the player is a winning contestant and the next web page level is displayed. If there is no match, the losing player is offered the chance to receive a consolation prize. The prize may be like other destination-oriented prizes that require the player to travel to the destination to receive the prize.

FIG. 6B shows a screen display 640 indicating no match is made. The player is offered with the opportunity to see which icon is the matching icon for winning the prize and the choice of whether accepting (icon 644) or declining (icon 646) a consolation prize. FIG. 6C shows a screen display 660 indicating the player does not wish to take the consolation prize. Screen display 660 thanks the player for playing and asks if the player wishes to play another game (icon 664). This assumes that not all of the prizes have been selected.

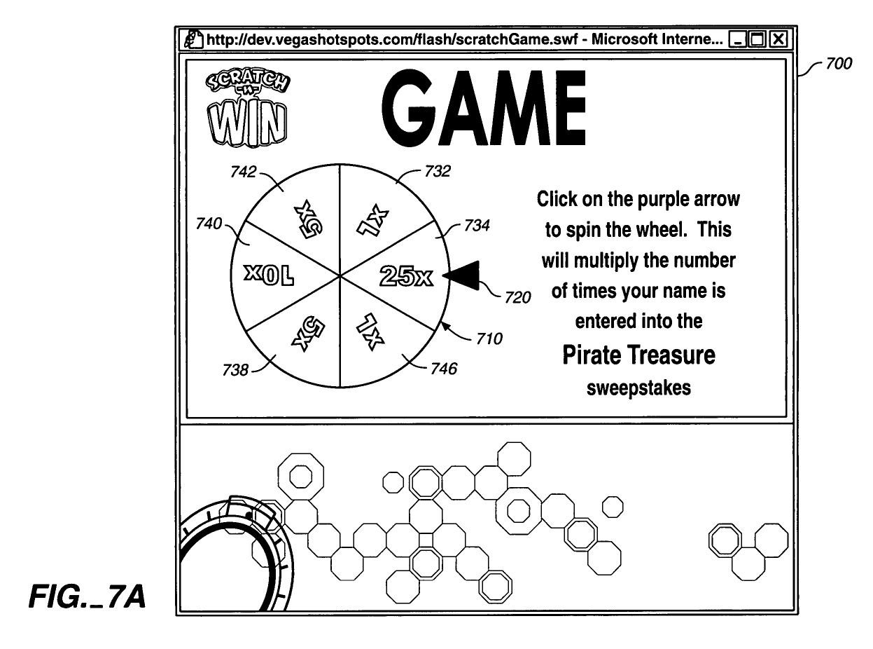

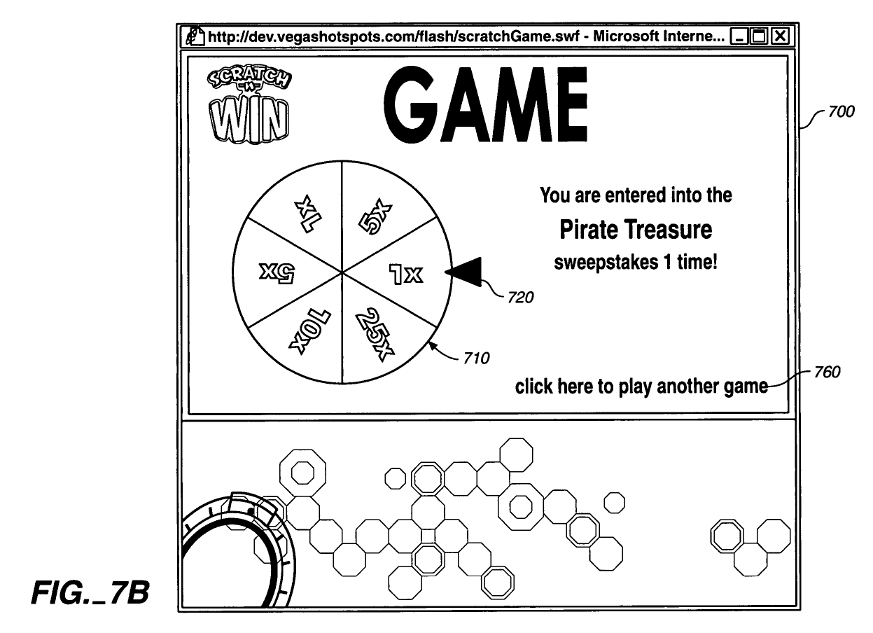

FIG. 7A illustrates a web page 700 presented to winners of the “Scratch and Win” game described above in connection with FIG. 6A. By way of example, web page 700 displays an electronic roulette wheel 710 and an invitation to the “Scratch and Win” game winner to click on an arrow icon 720 to electronically spin roulette wheel 710. As is typical of roulette wheels, electronically operated wheel 710 has a plurality of compartments, each containing one of a variety of random numbers. In the particular example shown in FIG. 7A, the compartments on roulette wheel 710 are six pie-shaped slices 732, 734, 746, 738, 740, and 742 containing 1×, 25×, 1×, 5×, 10×, and 5×, respectively. The player clicks arrow icon 720 to spin wheel 710, and wheel 710 stops with arrow icon 720 pointing to one of the numbered compartments. The particular number at which wheel 710 stops is a multiplier that the programmed system uses to increase the player's chances of winning the selected prize.

FIG. 7B is the web page 700 after the player clicked arrow icon 720 and wheel 710 has stopped at “1×”. By way of example, a message on web page 700 shown in FIG. 7B indicates that the player has been entered into the prize sweepstakes from a total of one time and the player is encouraged to “click here” (icon 760) and continue to play another game. In a preferred embodiment, the process for determining the sweepstake winner is similar to that for most raffle drawings. The winning contestant of “1×” has one entry added to a “squirrel cage” along with a number of other contest winners having from one to 25 entries per contestant added to the cage depending on the multiplier based on the spin of roulette wheel 710. The player with the winning entry pulled from the cage will be notified of the main prize, e.g., a four night stay for two in a given hotel or casino at the destination.

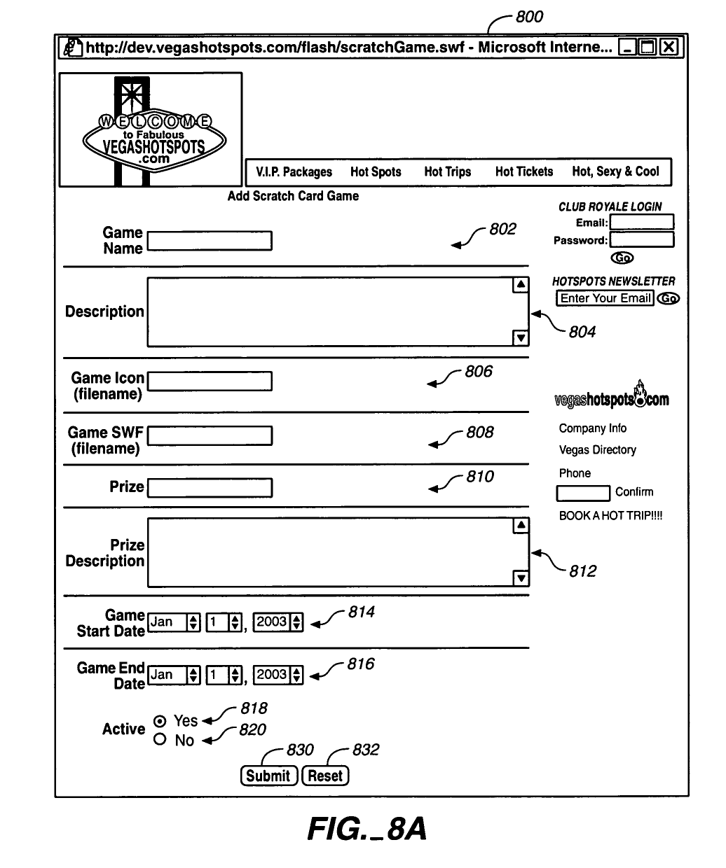

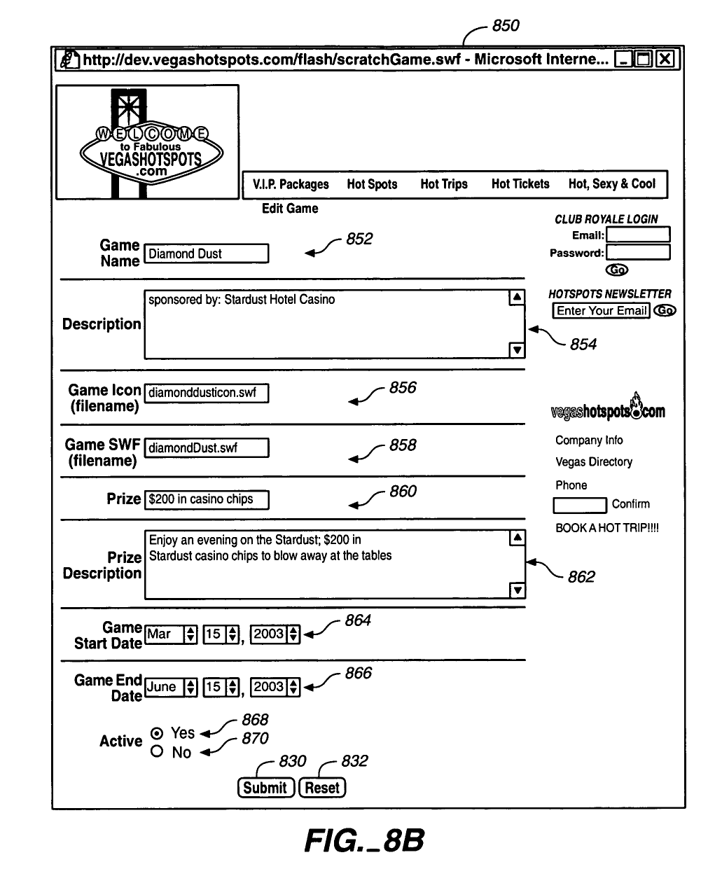

In the embodiment described above, four prizes were listed as shown in FIGS. 2 through 5B. Each time a player proceeds through the steps of the method described herein above in an attempt to win the raffle and obtain one of these prizes, the player is considered to have played one Scratch Card game. The title of each of these four games is the name selected by the sponsors of the prizes. A new Scratch Card game is added each time a new sponsor enters into a contract with the website host. FIG. 8A illustrates a screen display 800 having a form to be filled by the administrator for the website host in order to add a new sponsor. For each new sponsor, the information includes: the name of the game, i.e., the name of the sponsor wishes to use to designate the game (box 802); the full name and description of the sponsor (box 804); the game icon (box 806), the computer filename where the icon is stored and from which the icon is uploaded (box 808); the game file name (box 810), which is the filename of the game background and from which the game background is uploaded; a description of the prize (box 812); the date the game is to commence online (box 814); the date the game ends (box 816); and whether the game is to be active (box 818) or not (box 820) with no game going online until the yes box (box 818) is checked. After the form is completely filled out, the administrator clicks on submit button 830 to add a new sponsor to the database. The administrator can also click reset button 832 to re-enter the information. In a particular embodiment, the game file is a small web file (SWF). FIG. 8B illustrates a screen display 850 with all ten items of information filled in from the last input. The administrator can either click submit button 830 to upload the information or click reset button 832 to edit the information.

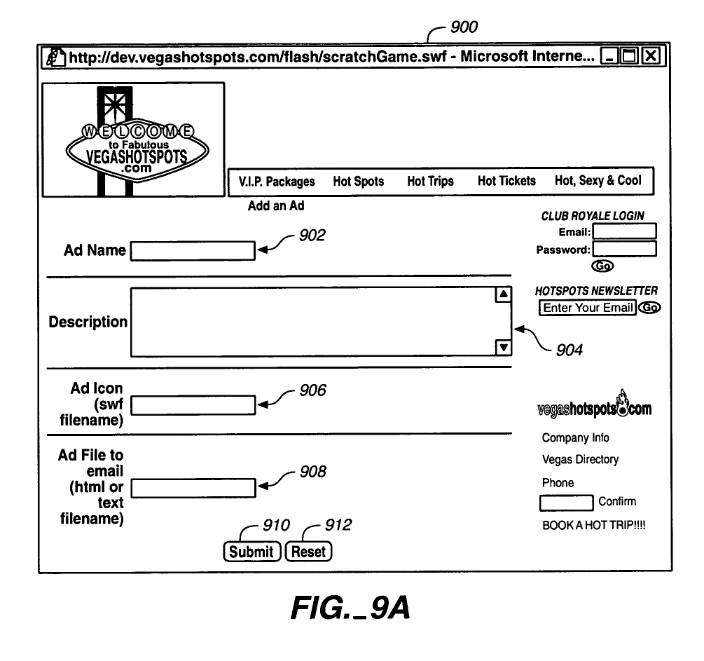

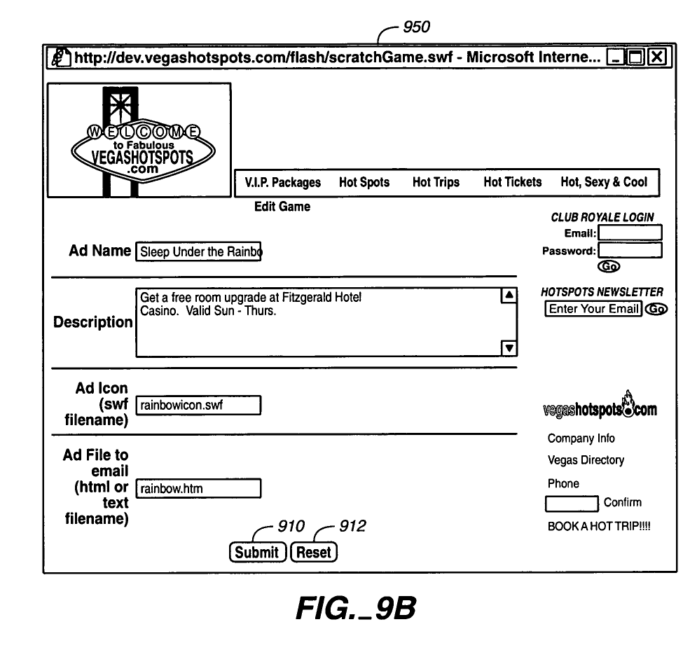

FIG. 9A illustrates a web page 900 displaying a form to be filled to add a new advertisement/consolation prize in accordance with an embodiment of the present invention. By way of example, the information includes the name of the consolation prize (box 902) as it appears online when the player is offered to take the prize; a complete description of the prize (box 904) that would appear underneath the ad when the player is offered to take the prize; the advertisement icon (box 906), e.g., a filename for a SWF file for storing the advertisement icon; the advertisement filename (box 908), e.g., an HTML file to be sent out as an e-mail for delivering the consolation prize after it is accepted. The administrator clicks on a submit button 910 to load the information to the database or a reset button 912 to further edit the information. FIG. 9B illustrates a screen display 950 with all the information filled in from the last input. The administrator clicks on a submit button 910 to load the information to the database or a reset button 912 to further edit the information.

Preferably, all of the forms are filled. Specifically the four game forms and four consolation forms are preferably completely filled. At that point, the administrator can select the games to be set up for going online, link a prize to the game, choose and link an advertisement/consolation prize for each game.

The website content in accordance with an embodiment of the present invention can be designed by using programming techniques known in the art. As an example, Appendix 1, entitled “Vegas Hot Spots Scratch Card Game”, and Appendix II, entitled “Vegas Hot Spots Scratch Card Game Creation Instructions”, set forth instructions for creating, maintaining the website in accordance with specific embodiments of the present invention. Appendices I and II are incorporated herein by reference in their entireties.

By now it should be appreciated that a simple and effective method for building a database of a self-selected class of consumer information has been provided. In accordance with the present invention, the method efficiently matches Internet users to merchants at certain geographic locations and attracts the users in traveling to and becoming consumers at those locations.

While various embodiments of the present invention have been described, they are not intended to limit the scope of the present invention, which is set forth in the appending claims. Various modifications of the above described embodiments can be made by those skilled in the art after browsing the specification of the subject application. These modifications are within the scope and true spirit of the present invention.

### Appendix I

### Vegas Hot Spots Scratch Card Game

Welcome Screen:

This is the initial screen that the player will see on the home page. It will serve only on that page and will be a separate SWF file from the main scratch card SWF. Its purpose is to graphically welcome the web surfer to the site and act as a redirection away from the main scratch card game if necessary.

| | |
|---|---|
| Database | Query the database to retrieve the following: |

1. link text: This is the text that will be displayed for the call to action link.
2. link: This is the actual HTTP link for the call to action.
3. company: The name of the company using the app.
3. logo filename: filename/location of the company logo to display on the
welcome screen.
3. tag line: This is the company's tag line.

| | |
|---|---|
| | If none of the information is supplied by a database, the welcome screen |
| | may default to proper information preset in the SWF file. |
| SWF | The SWF may display the following along with the proper graphics: |

“Welcome to Vegas Hot Spots”

(this company name could be replaced with the name
pulled from the database)

“<Company TAG LINE>”
“Play Scratch -n- Win to win fabulous Vegas Prizes.”
[Button]: The call to action button

For the scratch card game the button should read “Scratch
Away!”

[Button]: Close window button
Small MS Windows “x” close button placed in the top right.

| | |
|---|---|
| User | User mashes the call to action button thereby switching the SWF movie |

| | |
|---|---|
| interaction | to the scratch card game. |

The user mashes the close window button, which hides the DIV section

that the welcome screen sits on, and slides up the information
located below said section.

Scratch Card Login Screen:

The first screen the user will see of the actual scratch card game. Located in the left third of the screen is the login/register form. In the right two-thirds will be the game intro graphics along with a bit of information.

| | |
|---|---|
| Database | Query the database to get the different sweepstakes prizes. |
| Cookie | Check the surfer's computer for a cookie to see if they may bypass |

the login section.

| | |
|---|---|
| SWF | Left third: |

Display Welcome message.
Display login (username/password) fields.
Display login button.
Display reset button.
Display Register button.
Display “Forgot Password” link.

If the user bypassed the login by using a cookie then just replace the
left third with a personalized welcome message that lets them know
that they are already logged in.
Right two-thirds:

Display Scratch to Win graphic.
Display “Play Scratch to Win to win your next trip to Vegas”

message.

Display different types of sweepstakes prizes.

| | |
|---|---|
| User Interaction | Player may: |

Fill in login information and press submit button (username
and password fields are checked for valid information on
submit. If the information is invalid display an error message).
Press register button.
Click on “forgot password” link.

Submit Login Information

| | |
|---|---|
| Database | Query to validate the username and password. |
| | The username will most likely be the e-mail address of the surfer. |

On proper validation the database returns the unique userID
corresponding to the surfer's login information.
Unsuccessful validation will return a NULL for the userID.

| | |
|---|---|
| SWF | If the userID returned is not NULL then display a welcome message |

in the left third of the SWF and proceed to the Game Selection
screen.

If the userID returned is NULL then display a “Invalid

Username/Password” message and redisplay the login/register
fields.

Register User

| | |
|---|---|
| SWF | The left third changes to display fields for: |

First Name, Last Name, E-mail, Zip/Postal Code, County
(country will be a drop down combo box listing typical
countries with the US and UK at the very top of the list)

| | Also will be displayed the OPT out checkbox. |
|---|---|
| | Also will be displayed the register and reset buttons. |
| | Also will be displayed a link to the “privacy statement”. |
| User Interaction | Clicking the privacy statement link will open the privacy statement |

into a separate HTML window.

Clicking the register button will start the submission of the user's

information.

| | |
|---|---|
| SWF | On register, check the fields for information. If there are any empty |

fields display an error asking the user to complete the
registration.

| | |
|---|---|
| Database | Query the database to determine if the user already exists. |

If the user exists then return the user's userID.
If the user does not exist, then add that user to the database and
return the new userID.

| | |
|---|---|
| SWF | Display a personalized welcome message after successful registration |

and proceed to the Game Selection screen.

Forgot Password

| | |
|---|---|
| SWF | In left third: |

Prompt user for email address to send the password to.
Add a submit button.

| | |
|---|---|
| User Interaction | User enters their e-mail address and presses the submit button. |
| DYNAMIC | Query the database for the corresponding password to the supplied |

| | |
|---|---|
| PAGE/database | email. DYNAMIC page emails the password to the user. |

Scratch Card Game Selection

On this screen the player is presented with a choice of one to six different scratch card games to play.

| | |
|---|---|
| Database | Query the database for the following which is written out |
| | to an XML file: |

```
  1. Num. of Games
  2. File name/location of each game SWF and icon.
  3. Titles of games
  4. GameID
  5. Description of games
  6. Major prize of games
  7. How many major prize icons to place on the card
  (determined by how many times the player has lost
  at this game in a row?)
  8. Advertisement title
  9. Advertisement explanation
10. Advertisement icon
11. Consolation prize title
12. Consolation prize icon/image
```

| | |
|---|---|
| SWF | Left third of the screen: |

This area provides instructions to the player to select
a game by clicking on its card. It also provides a list of
major prizes available.

Right two-thirds of the screen:

Displays the Game Icons with their corresponding prize.

| | |
|---|---|
| Database | Query the database to determine which games the userID |

may play. This is determined by whether the player has
played a particular game within the past 24 hours.

| | |
|---|---|
| SWF | Gray out the games that the userID is not able to play. |
| User | If the user rolls over a game card icon a verbose explanation |

| | |
|---|---|
| Interaction | of the game will appear in a small window next to |
| | the cursor position and will follow they cursor until it |
| | rolls off the icon. |

Clicking on an icon will advance the user to that particular

scratch card game.

Scratch Card Game Card

This is the main playing screen for the scratch card game.

| | |
|---|---|
| SWF | Left third of screen: |

Explanation of how to play the game.
Link to official rules.

Right two-thirds:

Background Key art customized to the sponsor of the card.
Displays, for example, four scratch off boxes. The scratch foil

may have the Vegas Hot Spots flame printed on it. The
icon underneath will be one of two icons, the main prize or
the advertisement. Depending on how many main prize
icons were dictated to seed in the XML, random numbers
between 1 through 4 are drawn of where to place the main
prize icons until all that are to be placed have been placed.
It is suggested that the random number generator is seeded
with the current time in seconds, or some similar method.
The remaining unfilled spots are populated with the
advertisement icon.

Display the major prize icon that the player is trying to match.

| | |
|---|---|
| User interaction | The player scratches off one of the four scratch boxes. Scratching off |

one of the boxes may play a short (1-2 sec.) animation of the foil
being scratched away.

| | |
|---|---|
| SWF | If the scratched box reveals the advertisement, it may also show a brief |

explanation of that coupon next to the icon. More verbose details
may be displayed in the left third of the screen, as well as a button
that will e-mail that particular coupon to the player's e-mail when
clicked.

If the scratched box reveals the main prize icon, this is considered a

successful match.

Unsuccessful Match

| | |
|---|---|
| SWF | After the user selects to either accept or deny the offered coupon for the |

advertiser, the game declares a loser and all the unscratched boxes
are revealed. Following a slight pause the user may be presented
with the consolation prize in the right two-thirds. The left third
may hold a brief explanation of the prize and informs the user that
they will receive more information and details via email.

| | There is also a continue button in the right two-thirds of the screen. |
|---|---|
| Database | Query the database to store the userID and consolation prize won in the |

corresponding table. Use DYNAMIC PAGE to send the prize via
email.

Query the database to store information that the particular game/

gameID was played at current time and/or store the expiration
date/time along with the userID.

| | |
|---|---|
| User Interaction | Clicking on the continue button closes that game card and returns the |

user back to the game card selection screen.

Successful Match

| | |
|---|---|
| SWF | Declares a “Winner”. |
| | Right third shows an explanation of the sweepstakes that the player is |

entering.

Bonus spin wheel rolls in. Consists of 6 wedges: 1x, 25x, 1x, 5x, 10x,

5x.

Player is prompted to click on the wheel to spin for bonus entries into the

sweepstakes drawing.

| | |
|---|---|
| User Interaction | Player clicks on the bonus wheel to spin. Possibly could do a click drag |

to spin the wheel.

| | |
|---|---|
| SWF | Wheel animation of spin. |
| | If a click-drag spin is implemented, then the speed of the click-drag |

(S = R/T) may be measured and the wheel spun accordingly.

The wheel spins and slows down on one of the spots. The spot is

determined randomly by choosing a number one through six.
Odds are already determined by the number of times certain
bonuses appear on the wheel.

After the wheel halts, the player is informed that he is being entered in

the drawing for 1 times the bonus number spun.

| | A continue button appears at the bottom of the screen. |
|---|---|
| Database | Query the database to enter the player's userID or e-mail in to the table |

being kept to that particular sweepstakes.

Query the database to store information that the particular game/

gameID was played at current time and/or store the expiration
date/time along with the userID.

| | |
|---|---|
| User Interaction | Clicking on the continue button returns the player to the Game Selection |

Screen.

### Appendix II

### Vegas Hot Spots Scratch Card Game Creation Instructions

Icon Creation

Two icons may be created for each game. One icon is the game/main prize icon (sometimes the logo is a good idea). Another icon is the ad/consolation prize icon. The icons may be created with the same method.
1. Open the file “icon_template fla”.
2. Follow the instructions embedded in that file.
3. Save your icon files, however do not save over the template.
4. Upload the game icon SWF to the /flash/scratch_game directory.
   Upload the ad/consolation prize icon SWF to the /flash/scratch_ads directory.
      Game Background Creation

Follow the instructions below to create a background for your game.
1. Open the file “game_templatefla”.
2. Follow the instructions embedded in that file.
3. Save your game file, however do not save over the template.
4. Upload the SWF to the /flash/scratch_games directory.
   Adding the Game through the Administration Page

The administration page was set up to allow easy insertion and suspension functions to the database. Follow the instructions below to add a new scratch card game to the database.
1. Access the administration page by:
   http://dev.vegashotspots.com/cpanel/scratch_admin
2. Under the “Scratch Game” heading, click “Add”.
3. Fill in all the information as follows:
   Game Name: the name of the game as it appears in the game selection window.
   Description: the verbose description of the game that appears underneat the name in the game selection window.
Game Icon: the filename of the icon uploaded above (does not require path).
   Game SWF: the filename of the game background uploaded above (does not require path:
   Prize: the name of the major prize awarded for the game as it shall appear in the prize info window of the game selection window.
   Prize Description: the verbose description of the prize as it shall appear underneath the major prize name
   Game Start Date: the date the game shall commence (the game will not be available to play until this date has passed).
   Game End Date: the date the game shall end (the game will not be available to play once this date has passed).
   Active: choose whether or not to make the game active. Choosing “No” will make it unavailable to play.
4. Click “Subunit” and your game is added to the database.
   Adding an Advertisement/Consolation Prize through the Administration Page

Follow the instructions below to add a new advertisement/consolation prize to the database.
1. Access the administration page by:
   http://dev.vegashotspots.com/cpanel/scratch_admin
2. Under the “Ad” heading, click “Add”.
3. Fill in all the information as follows:
   Ad Name: The name of the advertisement/consolation prize as it appears when the player is awarded the prize.
   Description: The verbose description as it appears underneath the ad name when it is awarded.
   Ad Icon: the filename of the advertisement icon created above.
   Ad File to E-mail: the filename (preferably HTML) of the e-mail file that will be delivered to the player when awarded the prize and accepted. This file has to be a text file and can be HTML code.
4. Click “Subunit” to add your Ad to the database.
   Setting Up the Game

The final step in getting a scratch card game ready for play is to link an advertisement/consolation prize to its corresponding game. Follow the instructions below to accomplish this step.
1. Access the administration page by:
   http://dev.vegashotspots.com/cpanel/scratch_admin
2. Under the “Setup Game” heading, click “Setup”.
3. Choose a game that you wish to link a prize to by click on its name.
4. For the “Choose an Ad” dropdown box, select the ad that you wish to link to the game.
5. Click “Subunit” to link your Ad to the game.

1. An online method for online marketing, comprising:
providing an website having an Internet address accessible to a plurality of standard Internet browsers, the Internet address including a series of characters that conveys a name of a destination;
attracting a player having a possible interest in traveling to the destination to access the website using the Internet address;
displaying to the player a web page offering an opportunity to play an online game for a chance to win prizes;
displaying a list of the prizes;
requesting the player to register by providing at least one piece of player information in order to play the game in response to the player having not registered before; and
permitting the player an opportunity to play the online game and receive a prize in response to the player being a registered player.

2. The method of claim 1, wherein providing a website includes providing the website having the Internet address having a single word that in a manner conveys the destination.

3. The method of claim 1, wherein permitting the player an opportunity to play the online game includes giving the player an opportunity to win at least one destination-oriented prize.

4. The method of claim 1, wherein displaying to the player a web page offering an opportunity to play an online game includes presenting the player with the opportunity to play the online game on a home page of the website.

5. The method of claim 1, further comprising presenting a login page to the player in response to the player indicating an interest of playing the online game.

6. The method of claim 5, wherein displaying a list of prizes includes displaying the list of prizes at the login page.

7. The method of claim 5, wherein presenting a login page further includes presenting a registration page to the player requesting the player to register by providing the player's e-mail address in response to the player having not registered before.

8. The method of claim 7, wherein presenting a registration page to the player further includes requesting the player to select and confirm a password.

9. The method of claim 7, wherein displaying a list of prizes includes displaying the list of prizes after player has registered.

10. The method of claim 5, wherein presenting a login page further includes requesting the player to enter the player's e-mail address and a password in response to the player being a registered player.

11. The method of claim 10, wherein displaying a list of prizes includes displaying the list of prizes after the player's e-mail address is entered.

12. The method of claim 1, wherein permitting the player an opportunity to play the online game includes giving the player an opportunity to select one prize from the list of prizes that the player wishes to win.

13. The method of claim 12, further comprising displaying a web page for a scratch-off game, in which the player tries to match an icon with one of a plurality of images in response to the player selecting one prize from the list of prizes.

14. The method of claim 13, further comprising displaying a web page offering the player a destination-oriented consolation prize in response to the player not selecting a matching image.

15. The method of claim 13, further comprising displaying a web page giving the player an opportunity to proceed to a next game page in response to the player selecting a matching image.

16. The method of claim 15, wherein displaying a web page giving the player an opportunity to proceed to a next game page includes displaying the web page graphically displaying a roulette wheel capable of electronically spinning and resulting in one of a series of numbers that represented a series of chances of winning the prize selected by the player depending on the number at which the wheel comes to rest.

17. The method of claim 13, further comprising determining a number of times that the player is given to select a matching image within a period.

18. The method of claim 17, further comprising selecting the period to be 24 hours.

19. A system for online marketing, comprising:
means for providing an website having an Internet address accessible to a plurality of standard Internet browsers, the Internet address including a series of characters that conveys a name of a destination;
means for attracting a player having a possible interest in traveling to the destination to access the website using the Internet address;
means for displaying to the player a web page offering an opportunity to play an online game for a chance to win prizes;
means for displaying a list of the prizes;
means for requesting the player to register by providing at least one piece of player information in order to play the game in response to the player having not registered before; and
means for permitting the player an opportunity to play the online game and receive a prize in response to the player being a registered player.

20. The system of claim 19, wherein the means for providing a website includes means for providing the website having the Internet address having a single word that in a manner conveys the destination.

21. The system of claim 19, wherein the means for permitting the player an opportunity to play the online game includes means for giving the player an opportunity to win at least one destination-oriented prize.

22. The system of claim 19, wherein the means for displaying to the player a web page offering an opportunity to play an online game includes means for presenting the player with the opportunity to play the online game on a home page of the website.

23. The system of claim 19, further comprising means for presenting a login page to the player in response to the player indicating an interest of playing the online game.

24. The system of claim 23, wherein the means for displaying a list of prizes includes means for displaying the list of prizes at the login page.

25. The system of claim 23, wherein the means for presenting a login page further includes means for presenting a registration page to the player requesting the player to register by providing the player's e-mail address in response to the player having not registered before.

26. The system of claim 25, wherein the means for presenting a registration page to the player further includes means for requesting the player to select and confirm a password.

27. The system of claim 25, wherein the means for displaying a list of prizes includes means for displaying the list of prizes after player has registered.

28. The system of claim 23, wherein the means for presenting a login page further includes means for requesting the player to enter the player's e-mail address and a password in response to the player being a registered player.

29. The system of claim 28, wherein the means for displaying a list of prizes includes means for displaying the list of prizes after the player's e-mail address is entered.

30. The system of claim 19, wherein the means for permitting the player an opportunity to play the online game includes means for giving the player an opportunity to select one prize from the list of prizes that the player wishes to win.

31. The system of claim 30, further comprising means for displaying a web page for a scratch-off game, in which the player tries to match an icon with one of a plurality of images in response to the player selecting one prize from the list of prizes.

32. The system of claim 31, further comprising means for displaying a web page offering the player a destination-oriented consolation prize in response to the player not selecting a matching image.

33. The system of claim 31, further comprising means for displaying a web page giving the player an opportunity to proceed to a next game page in response to the player selecting a matching image.

34. The system of claim 33, wherein the means for displaying a web page giving the player an opportunity to proceed to a next game page includes means for displaying the web page graphically displaying a roulette wheel capable of electronically spinning and resulting in one of a series of numbers that represented a series of chances of winning the prize selected by the player depending on the number at which the wheel comes to rest.

35. The system of claim 31, further comprising means for determining a number of times that the player is given to select a matching image within a period.

36. The system of claim 35, further comprising means for selecting the period to be 24 hours.
